(19) United States
(12) Patent Application Publication
(10) Pub. No.: US 2019/0014625 A1
(43) Pub. Date: Jan. 10, 2019

(54) HEAT-COOKING DEVICE, HEAT-COOKING DEVICE CONTROL METHOD, AND HEAT-COOKING SYSTEM

(71) Applicant: Panasonic Intellectual Property Management Co., Ltd., Osaka (JP)

(72) Inventors: GANTETSU MATSUI, Kyoto (JP); HIROHISA IMAI, Shiga (JP)

(21) Appl. No.: 16/128,425

(22) Filed: Sep. 11, 2018

Related U.S. Application Data
(63) Continuation of application No. PCT/JP2017/010568, filed on Mar. 16, 2017.

(30) Foreign Application Priority Data
Mar. 23, 2016 (JP) 2016-057959

(51) Int. Cl. H05B 6/64; H05B 6/68; F27D 21/02; G06T 7/50; G06K 9/32

(52) U.S. Cl. CPC H05B 6/6438; H05B 6/6441; H05B 6/687; F27D 2019/0003; G06T 7/50; G06K 9/325; F27D 2021/026; F27D 21/02

(57) ABSTRACT

A heat-cooking device includes shape information reading and analyzing unit (204), information storage unit (205), and controller (203). In a case where shape information read by shape information reading and analyzing unit (204) has been registered in information storage unit (205), the heat-cooking device performs heating control based on heating control information registered in information storage unit (205) with being associated with the shape information. In a case where the shape information read by shape information reading and analyzing unit (204) has not been registered in information storage unit (205), a shape of a label attached to an object to be heated or a character printed on the label is read from an image taken by imaging unit (202), and the heat-cooking device performs heating control based information thus read.

### TECHNICAL FIELD

The present disclosure relates to a heat-cooking device, a heat-cooking device control method, and a heat-cooking system that cause heating control to be performed based on an image taken by a camera installed in the heat-cooking device.

### BACKGROUND ART

A microwave oven is known as an example of a heat-cooking device. In such a microwave oven, when a user presses a button to start heating after inputting a heating time and the like, cooking is performed. At stores such as a convenience store and a supermarket where packed meals or prepared foods packed in containers are sold, store clerks (users) may offer a service of cooking purchased food in a microwave oven.

Such a cooking service will be described below. The containers of packed meals and prepared foods usually carry an indication of an optimal heating time for heating such food in a microwave oven. A user checks the indication and sets the heating time in a microwave oven before heating an object to be heated. The microwave oven has an operation unit which includes numeric keys, for example, allowing setting of the heating time (minute, second).

In some cases, the microwave oven has a plurality of operation buttons, to which different heating times are assigned. In this case, the store clerk selects a button corresponding to the food to be heated, thereby heating the food under heating control suitable for the food to provide the heated food to a customer.

However, this configuration requires the user to input a heating time and the like on each occasion, which is a bothersome operation for the user.

To solve such a problem, a technique of automatically setting a heating time and the like in a microwave oven has been proposed. For example, PTL 1 proposes a technique where a camera installed in a heat-cooking device takes an image of an object to be cooked before cooking, recognition is performed on the image thus taken in a microwave oven, and then cooking is performed with a cooking method corresponding to the image on which recognition has been performed.

Such a conventional technique has, however, the following problems. First, from a whole image taken by the camera installed in the heat-cooking device, an image of food and a target barcode or marker section need to be recognized, which requires a long time for image recognition processing. Furthermore, depending on a position where food is placed, the microwave oven may fail to recognize the marker section itself or falsely recognize the marker section. Moreover, in a case where a label attached to food is not shown in the image thus taken or is shown but physically unrecognizable, necessary information cannot be detected.

### CITATION LIST

### Patent Literature

PTL 1: Unexamined Japanese Patent Publication No. 2010-61382

### SUMMARY OF THE INVENTION

In view of the above-described problems, the present disclosure provides a heat-cooking device, a heat-cooking device control method, and a heat-cooking system that eliminate the need of bothersome work such as input of a heating time setting and allows a user to easily cook an object to be heated.

Specifically, the heat-cooking device according to one exemplary embodiment of the present disclosure includes a heating chamber, a heater configured to heat an object to be heated in the heating chamber, an imaging unit configured to take an image of an interior of the heating chamber, and a controller configured to control heating generated by the heater. The heat-cooking device according to the one exemplary embodiment of the present disclosure further includes a shape information reading and analyzing unit configured to read shape information of the object to be heated from the image taken by the imaging unit and an information storage unit where heating control information is registered with the heating control information being associated with the shape information of the object to be heated. In the heat-cooking device according to the one exemplary embodiment of the present disclosure, the controller performs heating control based on heating control information registered in the information storage unit, the heating control information being associated with the shape information, in a case where the shape information read by the shape information reading and analyzing unit has been registered in the information storage unit.

This configuration causes heating control to be performed based on the heating control information registered in advance with the heating control information being associated with the shape information thus read. This eliminates the need of bothersome work such as input of a heating time setting and provides the heat-cooking device that allows a user to easily cook an object to be heated such as food.

### BRIEF DESCRIPTION OF DRAWINGS

FIG. 1 is a diagram showing an external appearance of a heat-cooking device according to a first exemplary embodiment of the present disclosure.

FIG. 2 is a block diagram showing a functional configuration of the heat-cooking device according to the first exemplary embodiment of the present disclosure.

FIG. 3A is a diagram showing examples of food and a shape of food, the food being cooked by the heat-cooking device according to the first exemplary embodiment of the present disclosure.

FIG. 3B is a diagram showing different examples of the food and the shape of food, the food being cooked by the heat-cooking device according to the first exemplary embodiment of the present disclosure.

FIG. 3C is a diagram showing still different examples of the food and the shape of food, the food being cooked by the heat-cooking device according to the first exemplary embodiment of the present disclosure.

FIG. 4 is a diagram showing an example of recognition of a character, a label, and a barcode in image recognition processing in the heat-cooking device according to the first exemplary embodiment of the present disclosure.

FIG. 5 is a flowchart showing the image recognition processing in the heat-cooking device of the first exemplary embodiment of the present disclosure.

FIG. 6 is a flowchart showing registration processing where heating control information is registered after the image recognition processing in the heat-cooking device of the first exemplary embodiment of the present disclosure.

FIG. 7 is a block diagram showing a functional configuration of a heat-cooking device of a second exemplary embodiment of the present disclosure.

FIG. 8 is a diagram showing an example of a table for an association between a shape of an object to be heated and heating control information in the heat-cooking device of the second exemplary embodiment of the present disclosure.

FIG. 9 is a flowchart showing image recognition processing in the heat-cooking device of the second exemplary embodiment of the present disclosure.

FIG. 10A is a diagram showing examples of food and a position where a food label is attached in the image recognition processing in the heat-cooking device of the second exemplary embodiment of the present disclosure.

FIG. 10B is a diagram showing different examples of the food and the position where the food label is attached in the image recognition processing in the heat-cooking device of the second exemplary embodiment of the present disclosure.

FIG. 10C is a diagram showing still different examples of the food and the position where the food label is attached in the image recognition processing in the heat-cooking device of the second exemplary embodiment of the present disclosure.

FIG. 11 is a diagram showing a different example of the table for an association between a shape of an object to be heated and heating control information in the heat-cooking device of the second exemplary embodiment of the present disclosure.

FIG. 12A is a diagram for describing an example where heating control is not performed on food in a heat-cooking device of a third exemplary embodiment of the present disclosure.

FIG. 12B is a diagram for describing a different example where heating control is not performed on food in the heat-cooking device of the third exemplary embodiment of the present disclosure.

FIG. 13 is a diagram showing an example of a table for an association between a shape of an object to be heated and heating control information in the heat-cooking device of the third exemplary embodiment of the present disclosure.

FIG. 14 is a block diagram showing a functional configuration of a heat-cooking system of a fourth exemplary embodiment of the present disclosure.

### DESCRIPTION OF EMBODIMENTS

A heat-cooking device according to one exemplary embodiment of the present disclosure includes a heating chamber, a heater configured to heat an object to be heated in the heating chamber, an imaging unit configured to take an image of an interior of the heating chamber, and a controller configured to control the heater for heating. The heat-cooking device according to the one exemplary embodiment of the present disclosure further includes a shape information reading and analyzing unit configured to read shape information of the object to be heated from the image taken by the imaging unit and an information storage unit where heating control information associated with the shape information of the object to be heated is registered. In the heat-cooking device according to the one exemplary embodiment of the present disclosure, in a case where the shape information read by the shape information reading and analyzing unit has been registered in the information storage unit, the controller performs heating control based on the heating control information registered in the information storage unit, the heating control information being associated with the shape information.

This configuration eliminates the need of bothersome work such as input of a heating time setting to allow the object to be heated and cooked easily under a heating control condition suitable for the object to be heated because heating control is performed based on the heating control information registered in advance, the heating control information being associated with the shape information read by the shape information reading and analyzing unit.

Furthermore, in the heat-cooking device according to the one exemplary embodiment of the present disclosure, in a case where the shape information read by the shape information reading and analyzing unit has not been registered in the information storage unit, at least one of a shape of a label attached to the object to be heated and a character printed on the label may be read as information from the image taken by the imaging unit. Further, in the heat-cooking device according to the one exemplary embodiment of the present disclosure, the controller may perform heating control in accordance with heating control information based on at least one of the shape of the label and the character which has been read as information.

This configuration causes, in a case where the shape information has not been registered in the information storage unit, at least one of label shape recognition and character recognition to be performed. Also, this configuration causes, in a case where the shape information has been registered in the information storage unit, heating control to be performed based on the heating control information associated with the shape information of the object to be heated (food) already registered in the information storage unit. Accordingly, the heating control information of the object to be heated is recognized more quickly and accurately. Furthermore, this eliminates the need of bothersome work such as input of a heating time setting, which allows the object to be heated to be cooked easily under a heating control condition suitable for the object to be heated.

Furthermore, in the heat-cooking device according to the one exemplary embodiment of the present disclosure, in a case where the shape information read by the shape information reading and analyzing unit has not been registered in the information storage unit, the controller may register the heating control information for heating the object to be heated and the shape information read by the shape information reading and analyzing unit in the information storage unit with the heating control information and the shape information being associated with each other.

This configuration causes, when the object to be heated is cooked for the first time, the shape information and the heating control information to be automatically associated with each other and then to be registered in the information storage unit. This eliminates the need for the user to perform a bothersome operation such as registration of a heating time for each object to be heated. This further allows cooking to be easily performed for the second time or later based on the heating control information registered in the information storage unit. Thus, the configuration allows the object to be heated to be cooked more easily under a heating control condition suitable for the object to be heated.

The heat-cooking device according to the one exemplary embodiment of the present disclosure further includes an operation unit through which heating control information set by the user is input. Furthermore, in the heat-cooking device according to the one exemplary embodiment of the present disclosure, the controller may register the heating control information set by the user through the operation unit and the shape information read by the shape information reading and analyzing unit in the information storage unit with the heating control information and the shape information associated with each other.

This configuration causes the controller to, in a case where the user manually sets the heating control information through the operation unit, automatically associate the shape information with the heating control information and register the shape information and the heating control information in the information storage unit. This eliminates the need for the user to the bothersome operation of registering the heating control information such as a heating time for each object to be heated when a similar object to be heated is cooked for the second time or later, which allows the object to be heated to be cooked more easily under a heating control condition suitable for the object to be heated.

The heat-cooking device according to the one exemplary embodiment of the present disclosure may further include a label information reading and analyzing unit configured to read a shape of a label attached to the object to be heated and a character information reading and analyzing unit configured to read a character printed on the label. In this case, the controller may read, as information, at least one of a shape of an object to be heated read by the shape information reading and analyzing unit, a shape of a label attached to the object to be heated read by the label information reading and analyzing unit, and a character printed on the label read by the character information reading and analyzing unit. Furthermore, in the heat-cooking device according to the one exemplary embodiment of the present disclosure, the controller may perform heating control based on the heating control information registered in the information storage unit with being associated with at least one of information of the shape of the object to be heated, information of the shape of the label, and information of the character printed on the label.

This configuration causes heating control to be performed based on the heating control information already registered in the information storage unit with being associated with the shape information of the object to be heated (food) even when the image taken by the imaging unit contains an unrecognizable label, character, or the like. This eliminates the need of bothersome work such as input of a heating time setting, which allows the object to be heated to be cooked easily under a heating control condition suitable for the object to be heated.

The heat-cooking device according to the one exemplary embodiment of the present disclosure may further include a shape determination unit configured to determine whether the shape information read by the shape information reading and analyzing unit has been registered in the information storage unit. In a case where a score value resulting from converting the shape information read by the shape information reading and analyzing unit into a numerical form lies within a predetermined score value range including a score value resulting from converting the shape information registered in the information storage unit into a numerical form, the shape determination unit may determine that the shape information read by the shape information reading and analyzing unit has been registered in the information storage unit. Furthermore, in a case where the score value resulting from converting the shape information read by the shape information reading and analyzing unit into a numerical form lies outside the predetermined score value range including a score value resulting from converting each shape information registered in the information storage unit into a numerical form, the shape determination unit may determine that the shape information read by the shape information reading and analyzing unit has not been registered in the information storage unit.

This configuration causes the heating control information associated with shape information of a shape most similar to the shape of the object to be heated thus read and registered in the information storage unit to be selected. Furthermore, in a case where the score value corresponding to the shape information of the shape of the object to be heated thus read lies outside the predetermined score value range, a determination is made that the shape of the object to be heated has not been registered in the information storage unit. This increases a recognition rate of a shape of an object to be heated. Thus, the configuration allows the object to be heated to be cooked easily under a heating control condition suitable for the object to be heated.

Furthermore, in the heat-cooking device according to the one exemplary embodiment of the present disclosure, in a case where shape information associated with the shape information read by the shape information reading and analyzing unit and registered in the information storage unit indicates that heating is not allowed, the controller need not perform heating control.

This configuration causes, in a case where food, a dish, and the like that are not allowed to be heated are present in the chamber, the controller to control heating to prevent cooking from being accidentally performed. This prevents the user from performing an erroneous operation.

Furthermore, in the heat-cooking device according to the one exemplary embodiment of the present disclosure, in a case where shape information associated with the shape information read by the shape information reading and analyzing unit and registered in the information storage unit indicates that heating is not allowed, the controller may provide a notification of the fact that heating is not allowed by indication or voice.

This configuration makes it possible to, in a case where food, a dish, and the like that are not allowed to be heated are present in the chamber, clearly notify the user of the fact.

Furthermore, the heat-cooking system according to the one exemplary embodiment of the present disclosure comprises a heat-cooking device and an external apparatus. The heat-cooking device of the heat-cooking system includes a heating chamber, a heater configured to heat an object to be heated in the heating chamber, an imaging unit configured to take an image of an interior of the heating chamber, a controller configured to control heating generated by the heater, and a first communication unit configured to receive information transmitted from the external apparatus to the controller. The external apparatus of the heat-cooking system includes a shape information reading and analyzing unit configured to read shape information of the object to be heated from the image taken by the imaging unit, an information storage unit where heating control information associated with the shape information of the object to be heated is registered, and a second communication unit configured to transmit the heating control information registered in the information storage unit to the first communication unit. The heat-cooking device and the external apparatus of the heat-cooking system are interconnected over a network via the first communication unit and the second communication unit to be capable of communicating with each other. Furthermore, in the heat-cooking system according to the one exemplary embodiment of the present disclosure, in a case where the controller determines that the shape information read by the shape information reading and analyzing unit and transmitted from the second communication unit to the controller via the first communication unit has been registered in the information storage unit, the controller performs heating control based on the heating control information registered in the information storage unit with the heating control information being associated with the shape information.

This configuration causes, in a case where the shape information has been registered in the information storage unit, heating control to be performed based on the heating control information already registered with being associated with the shape information of the object to be heated. Accordingly, the heating information of the object to be heated is recognized easily, quickly, and more accurately.

Furthermore, in the heat-cooking system according to the one exemplary embodiment of the present disclosure, in a case where the controller determines that the shape information read by the shape information reading and analyzing unit has not been registered in the information storage unit, at least one of a shape of a label attached to the object to be heated and a character printed on the label may be read as information from the image taken by the imaging unit. Then, in this case, the controller may perform heating control based on at least one of information of the shape of the label or information of the character which has been read.

This configuration causes, in a case where the shape information has not been registered, at least one of recognition of the shape of the label and recognition of the character to be performed, which allows the object to be heated to be cooked easily based on information thus recognized (read) under a heating control suitable for the object to be heated.

Furthermore, in the heat-cooking system according to the one exemplary embodiment of the present disclosure, in a case where the controller determines that the shape information read by the shape information reading and analyzing unit has not been registered in the information storage unit, the controller may register the heating control information for heating the object to be heated and the shape information read by the shape information reading and analyzing unit in the information storage unit with the heating control information and the shape information being associated with each other.

This configuration causes, when an object to be heated having a certain shape is cooked for the first time, information of the shape and heating control information to be automatically associated with each other and then to be registered in the information storage unit by the controller. This eliminates the need for the user to perform a bothersome operation such as registration of heating control information for each object to be heated. Thus, when a similar object to be heated is cooked for the second time or later, the configuration allows the object to be heated to be cooked easily.

The heat-cooking system according to the one exemplary embodiment of the present disclosure may further include a label information reading and analyzing unit configured to read a shape of a label attached to the object to be heated and a character information reading and analyzing unit configured to read a character printed on the label. Furthermore, in the heat-cooking system according to the one exemplary embodiment of the present disclosure, the controller may perform heating control based on the heating control information registered in the information storage unit with the heating control information being associated with at least one of the shape information of the object to be heated read by the shape information reading and analyzing unit, information of the shape of the label attached to the object to be heated read by the label information reading and analyzing unit, and information of the character printed on the label read by the character information reading and analyzing unit.

Even when the label or the character is unrecognizable in the image taken by the imaging unit, this configuration causes the shape information reading and analyzing unit or the like to read as information at least one of the shape of the object to be heated, the shape of the label attached to the object to be heated, and the character printed on the label directly from the label attached to the object to be heated. Then, heating control is performed based on the heating control information already registered in the information storage unit with the heating control information being associated with at least one of information of the shape of the object to be heated, information of the shape of the label attached to the object to be heated, and information of the character printed on the label read by the shape information reading and analyzing unit or the like. This allows the user to cook the object to be heated easily under a heating control condition suitable for the object to be heated.

Furthermore, in the heat-cooking device control method according to the one exemplary embodiment of the present disclosure, a heat-cooking device includes a heating chamber, a heater configured to heat an object to be heated in the heating chamber, an imaging unit configured to take an image of an interior of the heating chamber, a controller configured to control the heater for heating, and an operation unit through which heating control information set by a user is input. Furthermore, in the heat-cooking device control method according to the one exemplary embodiment of the present disclosure, the heat-cooking device includes a shape information reading and analyzing unit configured to read shape information of the object to be heated from the image taken by the imaging unit and an information storage unit where heating control information associated with the shape information of the object to be heated is registered.

In this method, in a case where the shape information read by the shape information reading and analyzing unit has been registered in the information storage unit, heating control is performed based on the heating control information registered in the information storage unit with being associated with the shape information.

Furthermore, in the heat-cooking device control method according to the one exemplary embodiment of the present disclosure, in a case where the shape information read by the shape information reading and analyzing unit has not been registered in the information storage unit, at least one of a shape of a label attached to the object to be heated and a character printed on the label may be read as information from the image taken by the imaging unit. Furthermore, heating control may be performed based on at least one of information of the shape of the label or information of the character thus read.

This method causes, in a case where the shape information has not been registered in the information storage unit, at least one of label shape recognition and character recognition to be performed. Thus, the method causes the heating control information to be recognized quickly and accurately and causes the object to be heated to be cooked easily under a heating control condition suitable for the object to be heated.

Furthermore, in the heat-cooking device control method according to the one exemplary embodiment of the present disclosure, the heating control information set by the user through the operation unit may be registered, by the controller, in the information storage unit with being associated with the shape information read by the shape information reading and analyzing unit.

This method causes, when the object to be heated is cooked for the first time, the shape information and the heating control information to be automatically associated with each other and then registered in the information storage unit. This eliminates the need for the user to perform a bothersome operation such as registration of a heating time for each object to be heated. This further allows cooking to be easily performed for the second time or later based on the heating control information registered in the information storage unit. Thus, the method allows the object to be heated to be cooked more easily under a heating control condition suitable for the object to be heated.

Exemplary embodiments of the present disclosure will be described below with reference to the drawings. The following exemplary embodiments should not be construed to limit the scope of the present disclosure.

### First Exemplary Embodiment

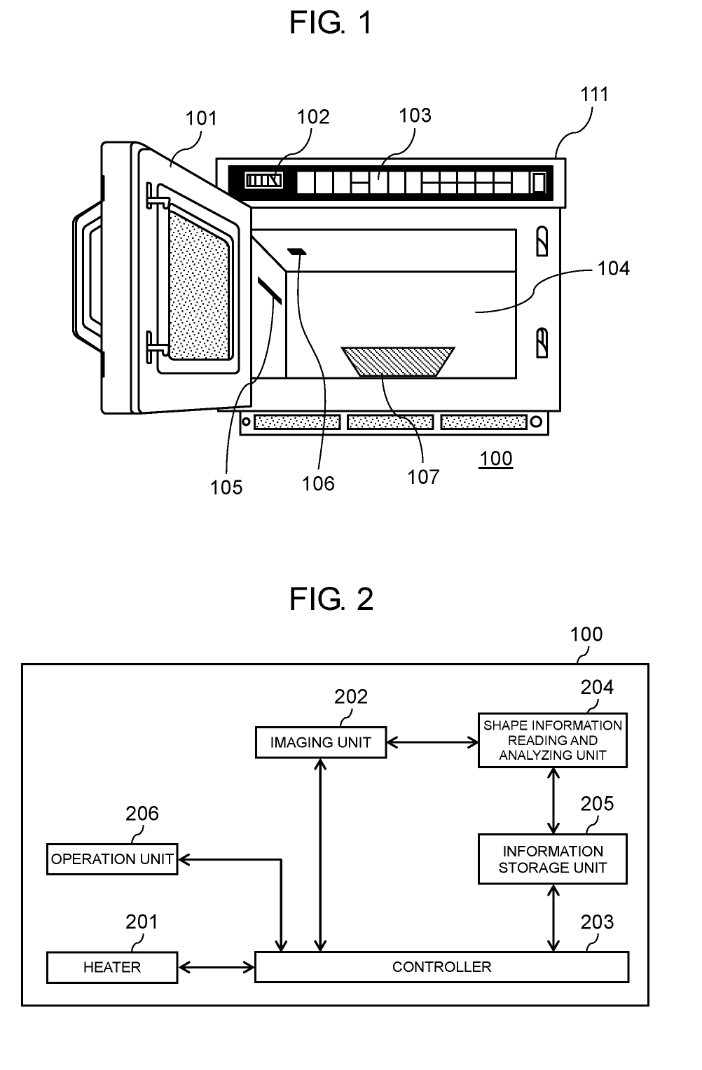

FIG. 1 shows an external appearance of a heat-cooking device according to a first exemplary embodiment of the present disclosure.

As shown in FIG. 1, heat-cooking device 100 has door panel 101 that allows food (an object to be heated) to be put into and taken out from housing 111 where food is stored. Heat-cooking device 100 includes heating information display unit 102 and selector 103 above door panel 101 of housing 111.

As described below, heat-cooking device 100 reads a heating time appropriate for food from an indication such as a label attached to the food and cooks the food for the heating time thus read. Heating information display unit 102 displays the heating time read.

Selector 103 includes a “menu” button that allows a user to select a menu corresponding to the food to be heated when, for example, the heating time fails to be read. Alternatively, selector 103 includes numeric buttons, and a “minute” button and a “second” button used for manually setting the heating time. Furthermore, selector 103 includes a “heating start button” used to start heating, and a “heating stop button” used to stop heating.

Heat-cooking device 100 further includes heat-cooking chamber (heating chamber) 104 in housing 111. Heat-cooking chamber 104 includes lighting unit 105 provided on a side surface of the chamber and camera 106 provided on a top surface of the chamber. Camera 106 is thus installed at a top of heat-cooking chamber 104, which enables camera 106 to take an image of a whole interior of the chamber from the top of the chamber. Camera 106 is electrically connected to a control circuit (not shown) provided in heat-cooking device 100 and is controlled by the control circuit.

Heat-cooking device 100 is configured to cause camera 106 to take an image of food 107 stored in heat-cooking chamber 104 and detect heating information of food 107 from information of the image thus taken.

Furthermore, heat-cooking device 100 includes, as described above, lighting unit 105 provided on a side surface of heat-cooking chamber 104. Lighting unit 105 is disposed on the side surface of the heat-cooking chamber 104 in the example shown in FIG. 1 and illuminates a whole interior of heat-cooking chamber 104 from the side surface of the chamber.

FIG. 2 is a block diagram showing a functional configuration of the heat-cooking device according to the first exemplary embodiment of the present disclosure.

As shown in FIG. 2, heat-cooking device 100 includes heater 201, imaging unit 202, controller 203, shape information reading and analyzing unit 204, information storage unit 205, and operation unit 206.

Heater 201 including, for example, a magnetron supplies a high-frequency wave to food placed in heat-cooking chamber 104 to heat the food.

Imaging unit 202 includes, for example, a complementary metal oxide semiconductor (CMOS) image sensor or a charge coupled device (CCD) image sensor and takes an image of the interior of heat-cooking chamber 104. Imaging unit 202 includes the above-described camera 106 and a control circuit.

Controller 203 controls heater 201 based on, for example, a state of heat-cooking chamber 104 taken by imaging unit 202 and heating control information of food to be heated.

Shape information reading and analyzing unit 204 detects a shape of food or information relating to the shape from the image taken by imaging unit 202 and analyzes whether the shape of the food or the information relating to the shape thus detected correspond to shape information (information of a shape). As the method for detecting a shape of food, a method based on information of a difference from a state where nothing is stored in the chamber is used, for example. Alternatively, a method for detecting a contour of food may be used. Furthermore, the shape information may contain not only food contour information but also image information of a whole food and information of a type of food or a heating control time associated with the image information.

Information storage unit 205 includes a non-volatile memory such as flash memory and stores, for example, shape information analyzed by shape information reading and analyzing unit 204 and heating control information based on which controller 203 performs heating control. Information storage unit 205 stores the shape information and the heating control information with the shape information and the heating control information associated with each other.

The heating control information contains a heating amount (wattage) and a heating time corresponding to the heating amount. Note that examples of information stored in information storage unit 205 include not only the shape information and the heating control information but also setting information of heat-cooking device 100, setting information of camera 106, and, information of heating control and operations.

Operation unit 206 includes, for example, a touch panel and a plurality of keys and is used by a user when the user sets a heating time, starts heating, or the like. Contents set through operation unit 206 are saved (registered) and stored in information storage unit 205.

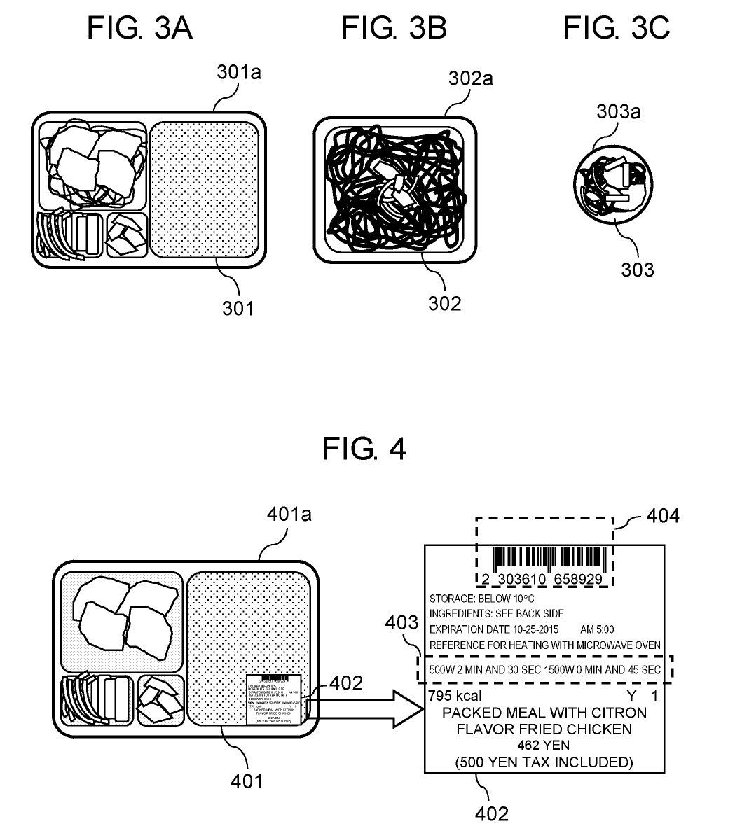

FIG. 3A to FIG. 3C show examples of food and a shape of food to be cooked by the heat-cooking device according to the first exemplary embodiment of the present disclosure. Specifically, FIG. 3A to FIG. 3C are diagrams showing examples of shape recognition in image recognition processing performed by shape information reading and analyzing unit 204.

Examples of food to be heated by heat-cooking device 100 include a packed meal, a rice ball, spaghetti, and soup with noodles. FIG. 3A to FIG. 3C show, as an example, food 301 corresponding to a packed meal, food 302 corresponding to spaghetti, and food 303 corresponding to soup with noodles, respectively. In FIG. 3A to FIG. 3C A, shape 301a corresponds to a shape of a packed meal, shape 302a corresponds to a shape of spaghetti, and shape 303a corresponds to a shape of soup with noodles.

FIG. 4 is a diagram showing an example of recognition of a character, a label, or a barcode in the image recognition processing performed by the heat-cooking device according to the first exemplary embodiment of the present disclosure. Specifically, FIG. 4 is a diagram showing an example of an image of a food label to be recognized and examples of barcode recognition and character recognition in the image recognition processing.

Note that, in the following exemplary embodiments, examples of such a barcode include not only a one-dimensional code but also a two-dimensional code such as a quick response code (QR) code.

FIG. 4 shows, as an example, food 401 corresponding to a packed meal. Attached to food 401 is label 402 indicating character information of a food name and a price and heating control information. Note that label 402 may indicate, as the heating control information, a heating amount and a heating time corresponding to the heating amount in a form that allows a user to directly recognize the heating amount and the heating time, or alternatively indicate the heating amount and the heating time corresponding to the heating amount in a form of a barcode.

In the example shown in FIG. 4, the heating time corresponding to the heating amount is indicated in heating control character target section 403 of label 402. In heating control character target section 403, respective heating times of a plurality of heating amounts are indicated. Specifically, two heating times for reference are indicated. One is 2 minutes and 30 seconds corresponding to a heating time for heating with a heating amount of 500 W, for example, as a reference for heating in a typical home-use microwave oven. The other is 0 minute and 45 seconds corresponding to a heating time for heating with a heating amount of 1500 W, for example, as a reference for heating in a commercial-use microwave oven. That is, “500 W 2 MIN 30 SEC 1500 W 0 MIN 45 SEC” is indicated, for example.

More specifically, heating control character target section 403 indicates, in the following order, a first character string, for example, “500”, which is a figure indicating a predetermined heating amount, a second character string, for example, “W”, which indicates a unit of the heating amount, a third character string, for example, “2”, which is a figure indicating a heating time at the heating amount; a fourth character string, for example, “MIN”, which indicates a unit of the heating time; a fifth character string, for example, “30”, which is a figure indicating the heating time at the heating amount; and a sixth character string, for example, “SEC”, which indicates a unit of the heating time.

Heating control character target section 403 further indicates, in the following order, a seventh character string, for example, “1500”, which is a figure indicating a heating amount exceeding the predetermined heating amount; an eighth character string, for example, “W”, which indicates a unit of the heating amount; a ninth character string, for example, “0”, which is a figure indicating a heating time at the heating amount; a tenth character string, for example, “MIN”, which indicates a unit of the heating time; an eleventh character string, for example, “45”, which is a figure indicating the heating time at the heating amount; and a twelfth character string, for example, “SEC”, which indicates a unit of the heating time.

In the present exemplary embodiment, “watt (W)”, which is a unit of heat amount specified by the International System of Units (SI), is used as the second character string and the eighth character string. However, any other character or unit may be used as long as the character or unit indicates a unit of heating power. Also, “MIN” or “SEC”, which is a character indicating a unit of time, is used as the fourth character string, the sixth character string, the tenth character string, and the twelfth character string. However, any other character or unit may be used as long as the character or unit indicates a unit of time.

Furthermore, in the example shown in FIG. 4, the barcode is indicated in barcode target section 404 of label 402.

Next, a description will be given of processing where, in heat-cooking device 100, shape information reading and analyzing unit 204 detects shape 301a of food from images of food (for example, refer to FIG. 3A to FIG. 3C) as the shape information, and the heating control is performed with the shape information thus detected associated with the heating control information.

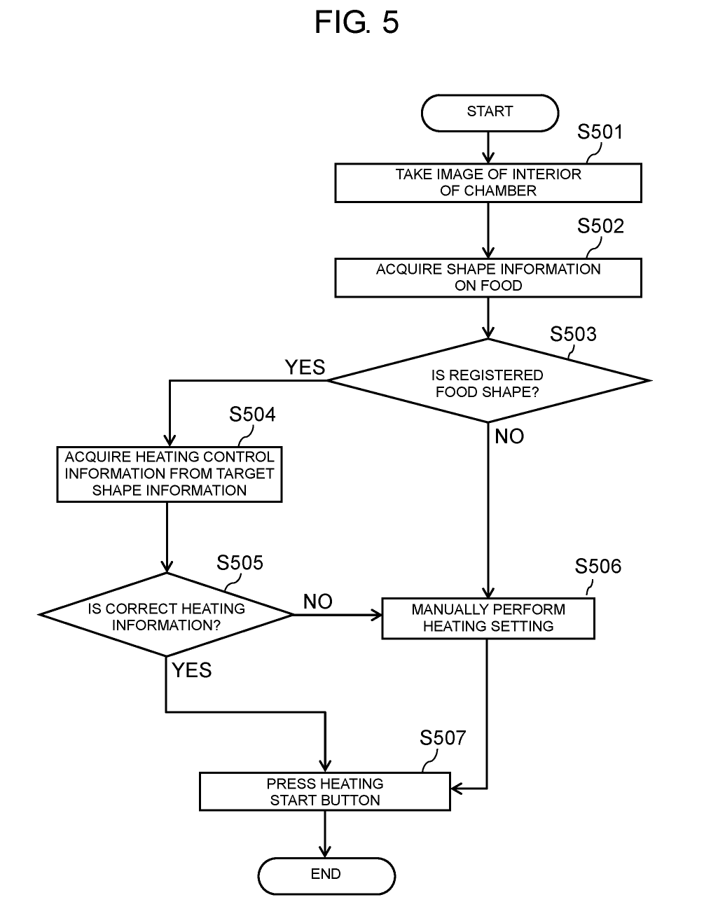

FIG. 5 is a flowchart showing the image recognition processing according to the first exemplary embodiment of the present disclosure.

In FIG. 5, when food is put into heat-cooking chamber 104, imaging unit 202 takes an image of the interior of the chamber (step S501).

From the image taken by imaging unit 202, shape information reading and analyzing unit 204 detects and acquires shape information of food to be heated (step S502).

Controller 203 determines whether the shape information of food thus detected (shape 301a in the present exemplary embodiment) has been stored in information storage unit 205 (step S503).

In a case where the shape information of food subject to the image recognition processing (shape 301a in the present exemplary embodiment) has been registered (stored) in information storage unit 205 (YES in S503), controller 203 acquires heating control information associated with shape information from information storage unit 205 (step S504). Contents of the heating control information thus acquired are displayed on heating information display unit 102.

A user confirms whether, from the contents displayed on heating information display unit 102, the heating control information associated with the shape information is correct heating control information. The user uses operation unit 206 to input a result of the confirmation (step S505).

In a case where, in step S505, the user determines that the heating control information is not correct for the food to be heated (NO in S505) or, in step S503, the user determines that the shape of food has not been registered (stored) in information storage unit 205 as shape information (NO in S503), the user manually performs a heating setting (for example, a heating amount setting and a heating time setting) with operation unit 206 (step S506).

In a case where, in step S505, the user determines that the heating information is correct for the food to be heated (YES in S505) or the user manually performs a heating setting with operation unit 206 (S506), the user presses the heating start button to start heating (step S507).

Accordingly, in heat-cooking device 100, the food is cooked at the heating amount included in the heating control information for the heating time included in the heating control information.

In the present exemplary embodiment, cooking is started after the heating start button is pressed in step S507; however, for the purpose of reducing operation loads imposed on the user, heat-cooking device 100 may be configured to automatically start cooking as long as a determination is made that the heating information is correct (YES in S505).

Next, a description will be given of processing where information storage unit 205 stores shape information analyzed by shape information reading and analyzing unit 204 and heating control information with the shape information and the heating control information associated with each other.

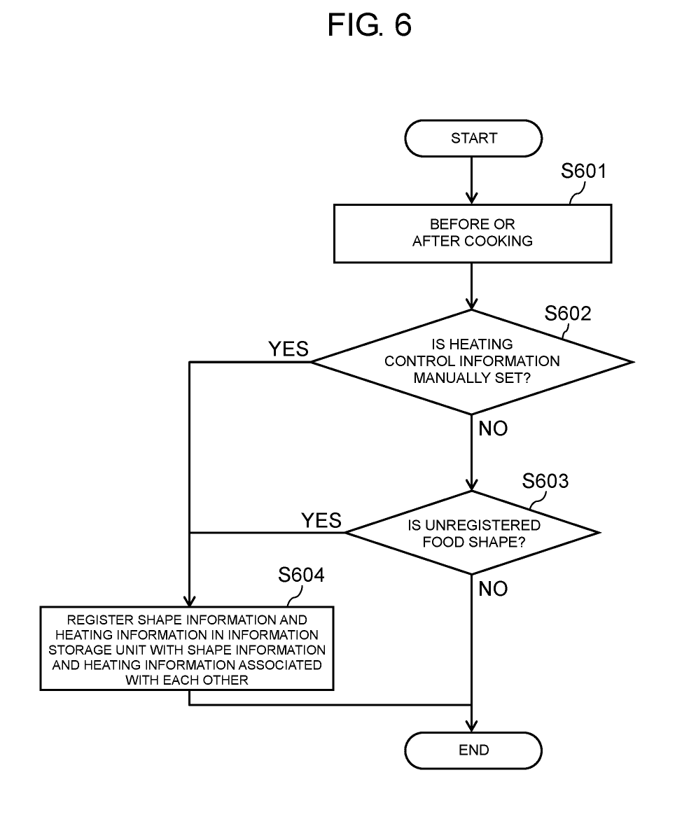

FIG. 6 is a flowchart showing registration processing where the heating control information is registered after the image recognition processing in the heat-cooking device according to the first exemplary embodiment of the present disclosure.

As shown in FIG. 6, the user first confirms whether heat-cooking device 100 is in a state before cooking or in a state after cooking (step S601).

In a case where heat-cooking device 100 is in the state before cooking or in the state after cooking, controller 203 determines whether the user has manually set heating control information (step S602).

In a case where controller 203 determines that the heating control information has not manually set (NO in S602), controller 203 determines whether shape information of food to be heated (shape 301a in the present exemplary embodiment) corresponds to a shape of food registered (stored) in information storage unit 205 (step S603).

In a case where controller 203 determines that the heating control information has been manually set (YES in S602) or determines that the shape information of the food to be heated (shape 301a in the present exemplary embodiment) corresponds to a shape of food that has not been registered (stored) in information storage unit 205 (YES in S603), controller 203 registers the shape information of the food to be heated (shape 301a in the present exemplary embodiment) in information storage unit 205 with the shape information associated with either heating control information based on which heating control is to be performed for heater 201 (for example, heating control information set by the user through the operation unit before cooking) or heating control information based on which heating control has been performed for heater 201 (for example, heating control information registered in information storage unit 205 after cooking) (step S604). Then, controller 203 ends the above-described registration processing.

Furthermore, in a case where controller 203 determines that shape information of food to be heated (shape 301a in the present exemplary embodiment) corresponds to a shape of food already registered (stored) in information storage unit 205, controller 203 terminates the flow without executing the registration processing in step S604.

In heat-cooking device 100 of the present exemplary embodiment, in a case where shape information of food has been registered in information storage unit 205, heating control is performed based on heating control information associated with the shape information of food already registered, which allows the heating control information of food to be quickly and accurately recognized.

Moreover, in heat-cooking device 100 of the present exemplary embodiment, for food to be cooked for the first time, shape information and heating control information are automatically associated with each other and registered in information storage unit 205 at the first time of cooking of the food. This configuration eliminates the need for a user to perform a bothersome operation such as the heating time setting. Furthermore, in a case where food having the same shape is cooked for the second time or later, cooking can be performed easily based on the heating control information associated with the shape information of the food registered in information storage unit 205.

### Second Exemplary Embodiment

A description will be given of a microwave oven as an example of a heat-cooking device according to a second exemplary embodiment of the present disclosure. In the second exemplary embodiment of the present disclosure, descriptions of structures, functional configurations, or control methods common to those of the first exemplary embodiment will not be given.

Heat-cooking device 200 of the second exemplary embodiment of the present disclosure is different from heat-cooking device 100 of the first exemplary embodiment in that information such as a character and a barcode indicated on, for example, a food label is read and analyzed in addition to a shape of food and heating control is performed based on determined information. Therefore, the present exemplary embodiment mainly focuses on the difference.

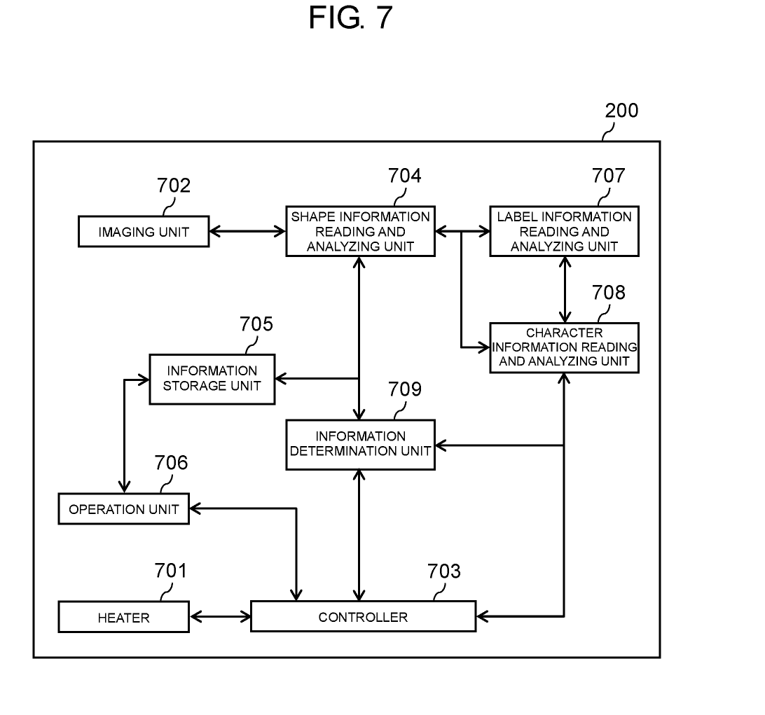

FIG. 7 is a block diagram showing a functional configuration of the heat-cooking device according to the second exemplary embodiment of the present disclosure.

As shown in FIG. 7, heat-cooking device 200 according to the second exemplary embodiment of the present disclosure includes heater 701, imaging unit 702, controller 703, shape information reading and analyzing unit 704, information storage unit 705, operation unit 706, label information reading and analyzing unit 707, character information reading and analyzing unit 708, and information determination unit (shape determination unit) 709.

Label information reading and analyzing unit 707 acquires a heating amount and a heating time corresponding to the heating amount from an image of a food label (for example, refer to FIG. 4). Label information reading and analyzing unit 707 recognizes label 402 attached to a packed meal in an image of food 401. Then, character information reading and analyzing unit 708 performs character recognition on heating control character target section 403 of label 402 and acquires the heating amount and the heating time corresponding to the heating amount. Alternatively, character information reading and analyzing unit 708 performs barcode recognition on barcode target section 404 of label 402 and acquires the heating amount and the heating time corresponding to the heating amount that have been registered in advance in information storage unit 705 with being associated with the barcode.

Label information reading and analyzing unit 707 further detects a section corresponding to a food label from a shape of food analyzed by shape information reading and analyzing unit 704 and analyzes whether the section corresponds to label shape information that is information of a shape of a food label. As the method for detecting a food label, a method for detecting a food label from a shape of food or a method for detecting a contour of a food label from a whole image may be used. Furthermore, provided that a position where a food label is attached is within almost the same range, a method for detecting a food label based on a relative position with respect to a shape of food may be used. Furthermore, the label shape information may contain not only contour information of a food label but also image information of a whole food label and information of a type of food and a heating control time associated with the image information.

Character information reading and analyzing unit 708 further detects a section corresponding to characters relating to heating of food (for example, heating control character target section 403 shown in FIG. 4) from a shape of a food label analyzed by label information reading and analyzing unit 707 and analyzes whether the section corresponds to character information as heating control information. As the method for detecting character information, a method for detecting character information from a shape of a food label or a method for detecting a section defined by a specific marker from a whole image or a whole food label may be used. Furthermore, provided that a position where a food label is attached is within almost the same range, a method for detecting character information based on a relative position with respect to a shape of food or a shape of a food label may be used. Furthermore, the character information may contain not only the heating control information but also image information of a character as the heating control information and information of, for example, a type of food and an expiration date associated with the image information.

Information determination unit (shape determination unit) 709 detects heating control information that is associated with, for example, shape information of food to be heated and stored in information storage unit 705, based on information analyzed by at least one of shape information reading and analyzing unit 704, label information reading and analyzing unit 707, and character information reading and analyzing unit 708, that is, based on at least one of shape information of food to be heated, label shape information, and character information and transmits the heating control information to controller 703.

Note that label information reading and analyzing unit 707 and character information reading and analyzing unit 708 each may be configured to serve as a component or a function of controller 703, or alternatively, may be configured to serve as a component or a function of shape information reading and analyzing unit 704.

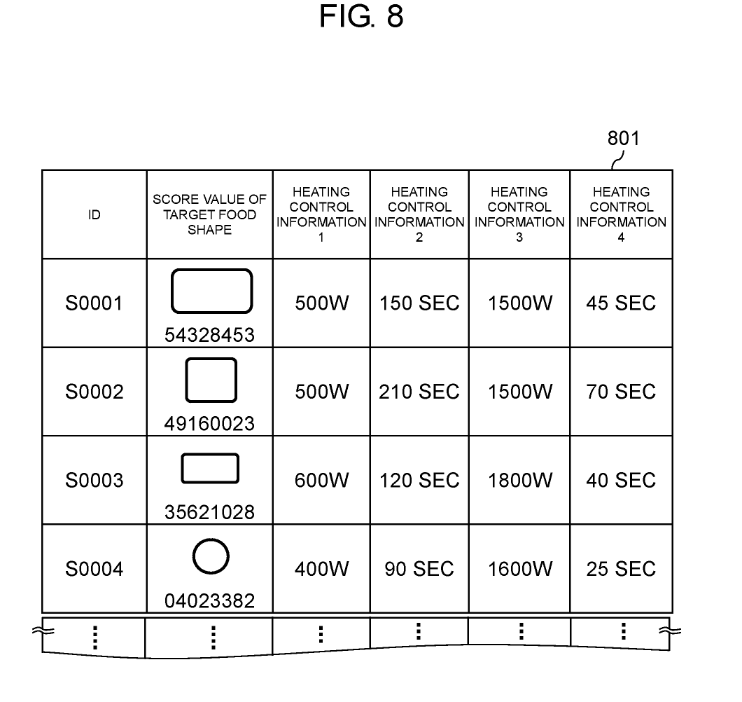

FIG. 8 is a diagram showing an example of a table for an association between a shape of an object to be heated and heating control information in the heat-cooking device of the second exemplary embodiment of the present disclosure.

Association table 801 that associates a shape of an object to be heated with heating control information contains, as shown in FIG. 8, an ID for identifying a shape of an object to be heated and a score value resulting from converting a shape as shape information of an object to be heated into an eight-digit number. Association table 801 further contains a first heating amount corresponding to heating control information 1 (wattage (W) in the present exemplary embodiment), a first heating time corresponding to heating control information 2, a second heating amount corresponding to heating control information 3 (wattage (W) in the present exemplary embodiment), and a second heating time corresponding to heating control information 4, all the pieces of information being associated with a shape of an object to be heated. The first heating time corresponding to heating control information 1 is a heating time used in a case where food to be heated (an object to be heated) is heated at the first heating amount, and the second heating time is a heating time used in a case where an object to be heated is heated at the second heating amount.

In FIG. 8, for example, ID S0001 is assigned with a large-size rectangular shape with rounded corners as a shape of an object to be heated. Note that the score value corresponds to a result from converting each piece of shape information into a numerical form to allow easier comparison among a plurality of shapes. For example, in the present exemplary embodiment, the score value is a value calculated from, for example, a contour or an area of an image. As a method for calculating a score value, a typical image comparison method may be used. Information storage unit 705 stores a score value resulting from converting shape information of food to be heated (an object to be heated) into a numerical form.

In the method for identifying a shape of food to be heated performed by information determination unit (shape determination unit) 709, when a score value corresponding to a shape of food to be heated lies within a predetermined score value range based on score values stored in information storage unit 705, a determination is made that the shape of food to be heated has been stored in information storage unit 705. Specifically, when a score value calculated from a contour or an area of an image of food to be heated lies within a score value range ±1000, both inclusive, of score values stored in information storage unit 705, information determination unit 709 determines that the shape of food to be heated has been stored in information storage unit 705. For example, in a case where a score value corresponding to a shape of an image of food to be heated taken is “54328376”, the score value lies within ±1000, both inclusive, of a score value “54328453” associated with ID S0001, a determination is made that a shape of the food to be heated corresponds to the shape of food assigned with ID S0001. Then, the food assigned with ID S0001 is associated with “500 W 150 SEC, 1500 W 45 SEC” that is heating control information based on association table 801.

Note that association table 801 is subject to the registration processing described in the first exemplary embodiment with reference to FIG. 6 and is saved (registered) in information storage unit 705 (information storage unit 205 in the first exemplary embodiment).

Furthermore, in the method for identifying a shape, a range ±1000 of a score value is used as an example of the predetermined score value range; however, a value indicating the predetermined score value range is not limited to this value, and any other value may be set as the predetermined score value range. Furthermore, a different value range may be set as the predetermined score value range for each shape. Furthermore, a setting of the predetermined score value range may be performed by the user through operation unit 706 such as an operation menu.

Furthermore, in the example shown in FIG. 8, four pieces of heating control information (heating control information 1 to heating control information 4) are present in association table 801 where a shape of an object to be heated is associated with heating control information; however, four pieces of heating control information are not always required, and a shape of an object to be heated may be associated with only one pair of a heating amount and a heating time (that is, two pieces of heating control information), or alternatively, four or more pieces of heating control information.

Next, a description will be given of processing where heating control is performed with information in an image taken by imaging unit 702 associated with heating control information.

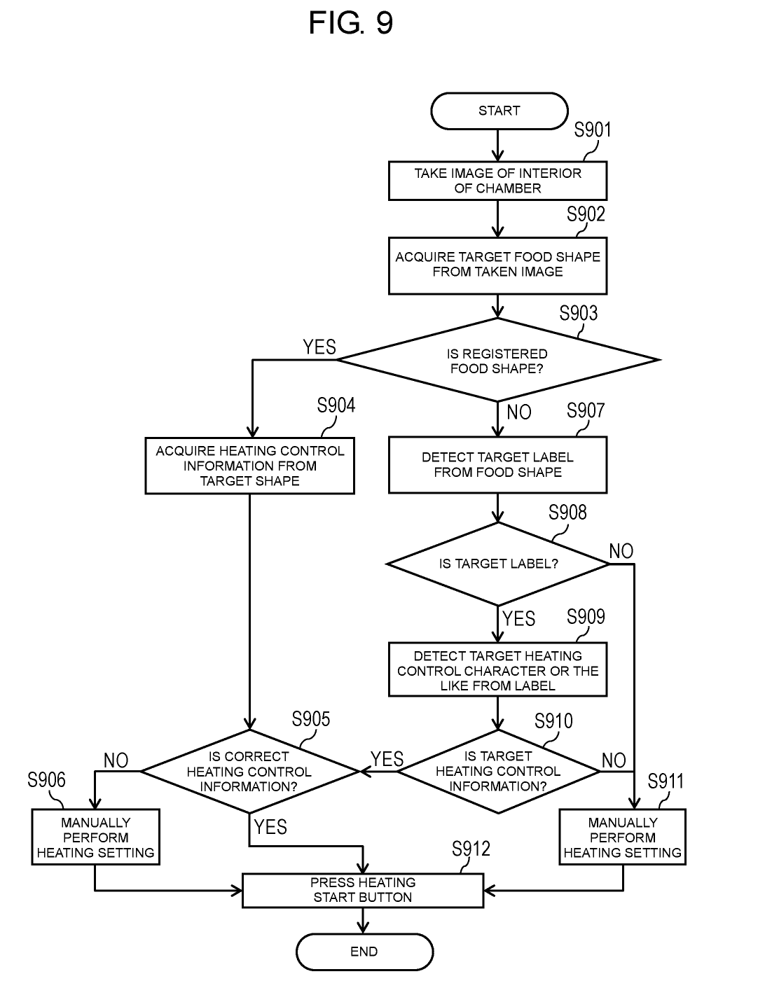

FIG. 9 is a flowchart showing image recognition processing in the second exemplary embodiment of the present disclosure. FIG. 9 shows heating processing where a shape of food to be heated corresponding to a section subject to image recognition (shape 401a in the present exemplary embodiment) is detected from an image of the food (for example, refer to FIG. 4), a target label corresponding to a section subject to image recognition (label 402 in the present exemplary embodiment) is detected from the shape of the food, and heating control character target section 403 corresponding to a section subject to image recognition is detected from the target label.

In FIG. 9, when food is put into heat-cooking chamber 104 and is in a state where imaging unit 702 can recognize the food, imaging unit 702 takes an image of the interior of the chamber (step S901).

From the image taken by imaging unit 702, shape information reading and analyzing unit 704 detects and acquires shape information of food to be heated (step S902).

Controller 203 determines whether shape 401a of food to be heated has been stored in information storage unit 705 (step S903).

In a case where the shape of the food to be heated (shape 401a in the present exemplary embodiment) has been registered (stored) in information storage unit 705 (YES in S903), heating control information associated with shape information is acquired from information storage unit 705 (step S904). Contents of the heating control information are displayed on heating information display unit 102 (refer to FIG. 1).

The user confirms whether, from the contents displayed on heating information display unit 102, the heating control information associated with the shape information is correct for the food to be heated (step S905). The user uses operation unit 706 to input the confirmation result.

In a case where the user determines that the heating control information is not correct for the food to be heated (NO in S905), the user manually performs a heating setting through the use of operation unit 706 (step S906).

In contrast, in step S903, controller 203 determines that the shape of the food to be heated has not been registered (stored) in information storage unit 705 (NO in S903), label information reading and analyzing unit 707 detects a target label (label 402 in the present exemplary embodiment) from the shape of the food (401a in the present exemplary embodiment (step S907).

Information determination unit 709 determines whether the label analyzed by label information reading and analyzing unit 707 corresponds to a label subject to image recognition processing (step S908).

In a case where label information reading and analyzing unit 707 determines that the label corresponds to a label subject to image recognition processing (label 402 in the present exemplary embodiment) (YES in S908), character information reading and analyzing unit 708 detects heating control character target section 403 or barcode target section 404 subject to image recognition processing (for example, heating control characters) from label 402 (step S909).

Information determination unit 709 determines whether heating control character target section 403 or barcode target section 404 analyzed by character information reading and analyzing unit 708 corresponds to heating control information subject to image recognition processing (step S910).

In a case where character information reading and analyzing unit 708 determines that it is heating control character target section 403 or barcode target section 404 subject to image recognition processing (YES in S910), contents of heating control information corresponding to heating control characters of heating control character target section 403 or a barcode of barcode target section 404 are displayed on heating information display unit 102 (refer to FIG. 1). Then, the user confirms whether, from the contents displayed on heating information display unit 102, the heating control information is correct for the food to be heated. The user uses operation unit 706 to input the confirmation result (step S905).

Information determination unit 709 determines that the target label is not present based on a result of the analysis performed by label information reading and analyzing unit 707 (NO in S908) or determines that heating control character target section 403 or barcode target section 404 is not present based on a result of the analysis performed by character information reading and analyzing unit 708 (NO in S910), the user manually performs a heating setting through the use of operation unit 706 (step S911).

In contrast, in a case where the user determines, in the above-described step S905, that the heating information is correct for the food to be hated in step S905 (YES in S905) and the user manually performs a heating setting through the use of operation unit 706 in step S906 or step S911, the user presses heating start button of operation unit 706 to start cooking of the food to be heated (step S912).

In heat-cooking device 200, cooking is performed in which heating at a heating amount included in heating control information continues for a heating time included in the heating control information. In association table 801 where a shape of an object to be heated is associated with heating control information, in a case where a plurality of heating amounts are associated with a plurality of heating times, each corresponding to one of the plurality of heating amounts as in the example shown in FIG. 8, cooking is performed in heat-cooking device 100 based on a heating amount close to heating capacity of heater 701 and a heating time corresponding to the heating amount in association table 801.

Note that, in the present exemplary embodiment, an example has been given where in a case where a shape of food to be heated (shape 401a in the present exemplary embodiment) has been registered (stored) in information storage unit 705, heating control information associated with shape information is acquired from information storage unit 705. However, for more accurate recognition, heating control information may be acquired based on not only shape information of food but also at least one of pieces of information relating to heating control information such as label shape information of food to be heated, character information, and barcode information.

Furthermore, in the present exemplary embodiment, cooking is started after the heating start button is pressed in step S912; however, for the purpose of reducing operation loads imposed on the user, heat-cooking device 200 may be configured to automatically start cooking as long as the user confirms that the heating information is correct (YES in S905).

Next, a detailed description will be given of an operation of heat-cooking device 200 of the present exemplary embodiment.

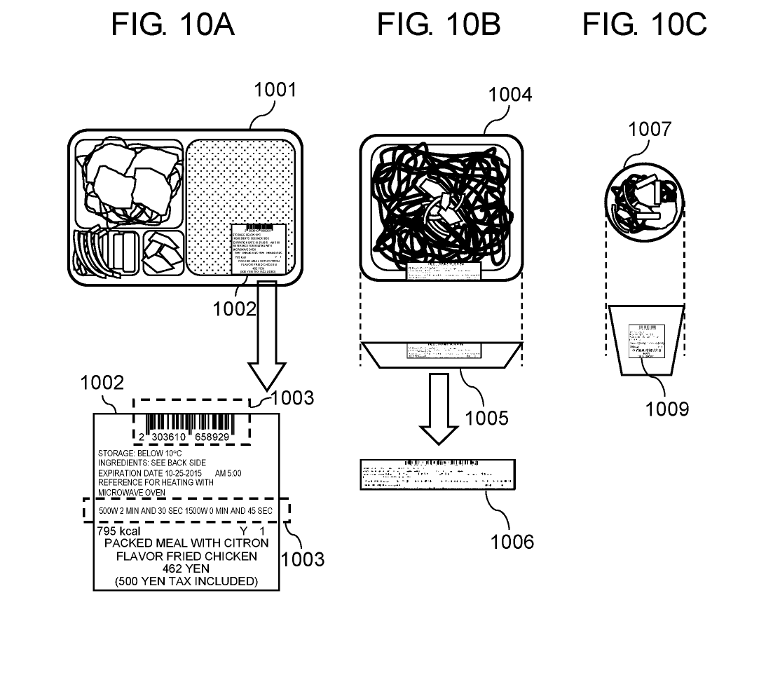

FIG. 10A to FIG. 10C are diagrams showing examples of food and a position where a food label is attached according to the heat-cooking device of the second exemplary embodiment of the present disclosure. Specifically, FIG. 10A shows an example where label 1002 and heating control character information 1003 subject to image recognition processing when imaging unit 702 takes an image are attached to a top surface of a container of packed meal 1001 where a whole of label 1002 and heating control character information 1003 is visible.

In heat-cooking device 200 of the present exemplary embodiment, in a case where such food is cooked for the first time, shape information and heating control information have not been registered in information storage unit 705 with the shape information and the heating control information associated with each other. In this case, in step S902, shape information reading and analyzing unit 704 detects a shape of food from an image of packed meal 1001 taken by imaging unit 702. Furthermore, in step S907, label information reading and analyzing unit 707 detects label 1002. Furthermore, in step S909, character information reading and analyzing unit 708 recognizes and detects a character or a barcode from label 1002 thus detected as heating control information 1003.

In the above-described flow of image recognition processing, in a case where the user confirms that heating control information 1003 is correct information in step S905, the user can start cooking only by pressing the heating start button in step S912.

Moreover, the heating control information acquired through the above-described flow of image recognition processing is saved (registered) in information storage unit 705 with being associated with shape information of packed meal 1001 based on processing similar to processing represented by the flowchart of registration of heating control information shown in FIG. 6.

Accordingly, in a case where food, such as shown in FIG. 10A, is cooked for the second time or later, heating control information 1003 can be acquired based on association table 801 where shape information is associated with heating control information. In a case where heating control information 1003 is correct information, the user can start cooking quickly and accurately only by pressing the heating start button.

FIG. 10B shows an example where target label 1006 is attached to an end of a top surface of a container of spaghetti 1004 or to a side surface 1005 of the container that is inclined. In such a case, even if imaging unit 702 takes an image, as with label 1006 shown in FIG. 10B, a character and a barcode printed on label 1006 are not correctly recognized. Furthermore, a size of label 1006 whose image has been taken from above the top surface of the container of spaghetti 1004 is different from an actual size of label 1006 and corresponds to a size of an image resulting from imaging only a part of label 1006, which prevents the size from being recognized as a size of a registered label.

As described above, even for a label that is difficult for imaging unit 702 to recognize, a label shape itself analyzed by label information reading and analyzing unit 707 is subject to recognition in image recognition processing, and heating control information is registered in information storage unit 705 with being associated with label shape information. Then, once the user manually cooks an object to be heated, heating control information based on which heating control has been performed is registered with being associated with label shape information. Accordingly, in a case where food such as shown in FIG. 10B is cooked for the second time or later, the user need not manually perform a setting for heating control, which allows the user to cook the food easily.

FIG. 10C shows an example where target label 1009 is attached to a side surface of a container of soup with noodles 1007. Such a case makes imaging unit 702 unable to take an image of the label itself.

As described above, for a label that imaging unit 702 cannot recognize, information indicating that no label is present and a shape of food analyzed by shape information reading and analyzing unit 704 are subject to image recognition processing, and heating control information is registered in information storage unit 705 with being associated with label shape information. Then, once the user manually cooks the food, heating control information based on which heating control has been performed is registered with being associated with shape information of food. Accordingly, in a case where food such as shown in FIG. 10C is cooked for the second time or later, the user need not manually perform a setting for heating control, which allows the user to cook the food easily.

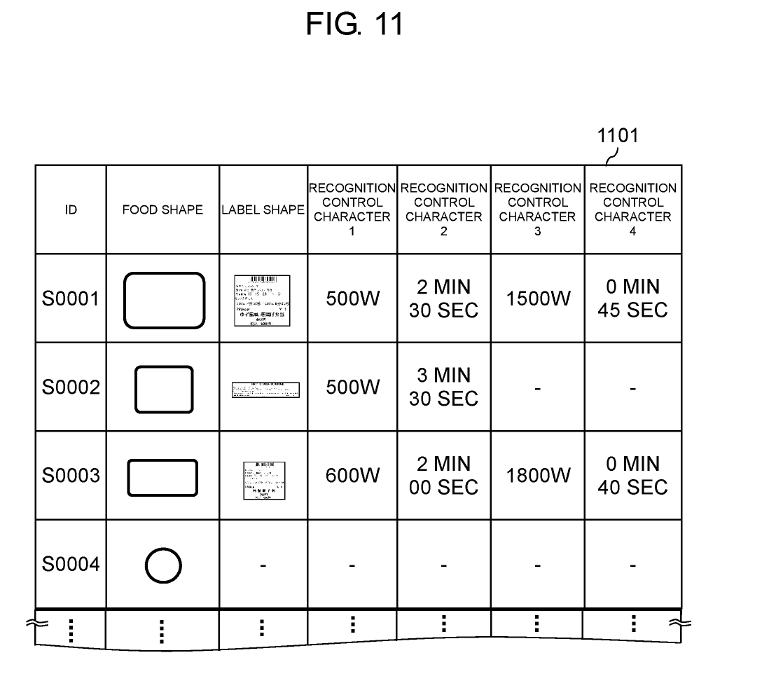

FIG. 11 is a diagram showing a different example of a table for an association between a shape of an object to be heated and heating control information in the heat-cooking device according to the second exemplary embodiment of the present disclosure.

Association table 1101 that associates a shape of an object to be heated with heating control information contains, as shown in FIG. 11, an ID for identifying a shape of an object to be heated, shape information of the object to be heated (food to be heated), and label shape information recognized and analyzed by reading and analyzing unit 704. Association table 1101 further contains a first heating amount (wattage (W)) corresponding to recognition control character 1 recognized and analyzed by character information reading and analyzing unit 708 and a second heating time corresponding to recognition control character 2 recognized and analyzed by character information reading and analyzing unit 708. Association table 1101 further contains a second heating amount (wattage (W)) corresponding to recognition control character 3 recognized and analyzed by character information reading and analyzing unit 708 and a second heating time corresponding to recognition control character 4 recognized and analyzed by character information reading and analyzing unit 708.

The content of the first character string in the first exemplary embodiment corresponds to the first heating amount in the present exemplary embodiment, and the contents of the third character string and the fifth character string in the first exemplary embodiment correspond to the first heating time in the present exemplary embodiment. Furthermore, the content of the seventh character string in the first exemplary embodiment corresponds to the second heating amount in the present exemplary embodiment, and the contents of the ninth character string and the eleventh character string in the first exemplary embodiment corresponds to the second heating time in the present exemplary embodiment.

For example, ID S0001 is assigned with a large-size rectangular shape with rounded corners as a shape of food to be heated. Furthermore, as with label 1002 shown in FIG. 10A, a label shape that is an approximately square shape is registered with being associated with ID S0001, the label shape making characters “PACKED MEAL WITH CITRON FLAVOR FRIED CHICKEN” and heating information “500 W 2 MIN and 30 SEC, 1500 W 0 MIN and 45 SEC” identifiable. As described above, for ID S0001, in association table 1101, the fact that the heating control information recognized by character information reading and analyzing unit 708 indicates “500 W 2 MIN and 30 SEC, 1500 W 0 MIN and 45 SEC” is registered.

In contrast, ID S0002 is assigned with a medium-size square shape with rounded corners as a shape of food to be heated. In this case, as with label 1006 shown in FIG. 10B, a label shape that is a thin and long rectangle shape is registered, the label shape making characters “CARBONARA” and heating information “500 W 3 MIN and 30 SEC, 1500 W 1 MIN and 10 SEC” difficult to be identified.

In heat-cooking device 200 of the present exemplary embodiment, even in a case where shape information of food has not been registered, heating control information is read from character information and barcode information of a food label attached to the food, and then cooking is performed. This configuration eliminates the need of a bothersome setting operation and allows cooking to be performed easily.

Moreover, in heat-cooking device 200 of the present exemplary embodiment, shape information of food to be heated and heating control information read by at least one of imaging unit 702, shape information reading and analyzing unit 704, label information reading and analyzing unit 707, and character information reading and analyzing unit 708 are automatically associated with each other and registered in information storage unit 705. This configuration eliminates the need for the user to perform a bothersome setting operation. Furthermore, in a case where food having the same shape is cooked for the second time or later, cooking can be performed easily based on heating control information associated with shape information of food thus registered.

Furthermore, in heat-cooking device 200 of the present exemplary embodiment, at least one of shape information of food to be heated, label shape information of a food label attached to food to be heated, character information printed on the food label, and barcode information printed on the food label is read by at least one of imaging unit 702, shape information reading and analyzing unit 704, label information reading and analyzing unit 707, and character information reading and analyzing unit 708. Then, in heat-cooking device 200 of the present exemplary embodiment, heating control is performed based on heating control information associated with the information thus read. This configuration allows the user to perform cooking easily with heat-cooking device 200.

Furthermore, in heat-cooking device 200 of the present exemplary embodiment, information determination unit 709 compares a score value resulting from converting a shape read by, for example, imaging unit 702 into a numerical form and a score value registered in information storage unit 705 and determines whether the shape corresponds to any shape of food registered in information storage unit 705 based on whether the score value lies within the predetermined score value range. This configuration increases a recognition rate of a shape of food to be heated, which allows heating control suitable for the food to be heated to be performed in heat-cooking device 200. This also increases reliability of heat-cooking device 200.

### Third Exemplary Embodiment

A description will be given of a microwave oven as an example of heat-cooking device 1200 according to a third exemplary embodiment of the present disclosure. For heat-cooking device 1200 of the third exemplary embodiment of the present disclosure, descriptions of structures, functional configurations, or control methods common to those of heat-cooking device 100 of the first exemplary embodiment and heat-cooking device 200 of second exemplary embodiment will not be given.

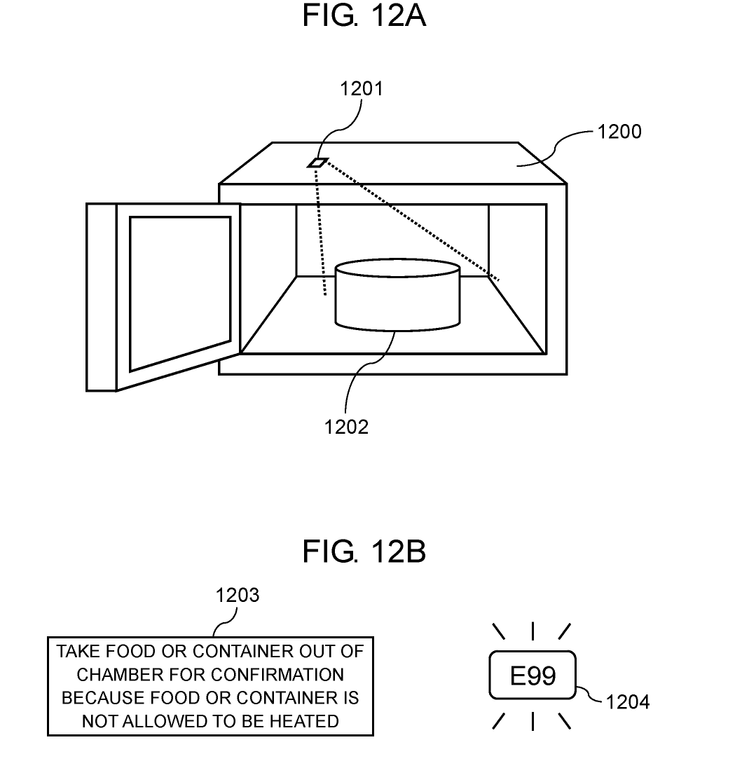

FIG. 12A and FIG. 12B are diagrams for describing an example where heating control is not performed on food to be heated in the third exemplary embodiment of the present disclosure. Specifically, FIG. 12A shows an example where food 1202 that is not subject to heating is put into heat-cooking device 1200. In this case, shape information of an image of food 1202 taken by imaging unit 1201 and heating control information indicating that heating control is not allowed are registered in information storage unit 205 with being associated with each other, which prevents the heating control from being erroneously performed.

Specifically, shape information of food 1202 that is not subject to heating is registered in information storage unit 205 with being associated with heating control information indicating that heating control is not performed. When food 1202 is put into the chamber and food 1202 is in a state where imaging unit 202 can recognize food 1202, imaging unit 202 takes an image of the interior of the chamber. From the image taken by imaging unit 1201, shape information reading and analyzing unit 204 detects and acquires shape information of food to be heated. Controller 203 determines whether the shape of the food thus detected corresponds to any information stored in information storage unit 205. In a case where controller 203 determines that the shape of the food put into the chamber is identical to shape information registered (stored) in information storage unit 205, controller 203 acquires heating control information associated with the shape information from information storage unit 205. In contrast, the content of heating control information indicating that heating control is not performed on food 1202 is notified to the user as described below. Furthermore, the heating control information indicating that heating control is not performed on food 1202 is sent to controller 203. In this case, controller 203 does not perform heating control even when the user presses the heating start button.

Note that examples of food 1202 that is not subject to heating include food such as canned food that is not allowed to be heated in a microwave oven.

FIG. 12B shows an example of a mode of notification to a user in a case where food 1202 that is not subject to heating is put into heat-cooking device 1200. In a case where food 1202 is not allowed to be heated, the fact that the heating control cannot be performed is notified to the user by at least one of reading aloud a message, displaying a message on display unit 1203 that is an example of heating information display unit 102, and turning on and off display unit 1204 that is another example of heating information display unit 102. A specific example of the message is, for example, “TAKE FOOD OR CONTAINER OUT OF CHAMBER FOR CONFIRMATION BECAUSE FOOD OR CONTAINER IS NOT ALLOWED TO BE HEATED” as displayed on display unit 1203 shown in FIG. 12B.

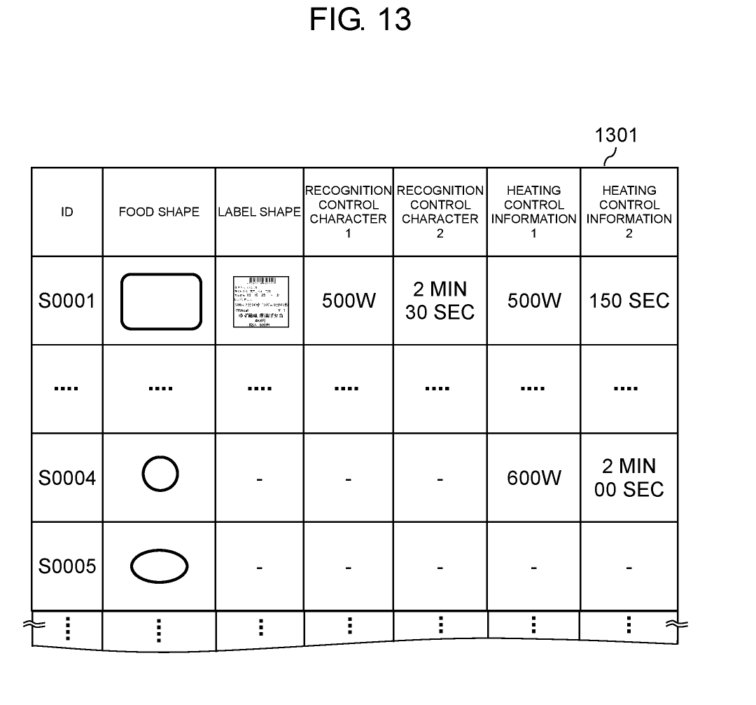

FIG. 13 is a diagram showing an example of a table for an association between a shape of an object to be heated and heating control information in the heat-cooking device of the third exemplary embodiment of the present disclosure. Association table 1301 that associates a shape of an object to be heated with heating control information contains, as shown in FIG. 13, an ID for identifying a shape of an object to be heated, shape information of food to be heated, and label shape information recognized and analyzed by reading and analyzing unit 704. Association table 1301 further contains a first heating amount (wattage (W)) corresponding to recognition control character 1 recognized and analyzed by character information reading and analyzing unit 708 and a first heating time corresponding to recognition control character 2 recognized and analyzed by character information reading and analyzing unit 708. Association table 1301 further includes a second heating amount (wattage (W)) corresponding to heating control information 1 associated with a shape of food to be heated and a shape of a label on the food to be heated and a second heating time corresponding to heating control information 2 associated with the shape of the food to be heated and the shape of the target label.

Note that the content of the first character string or the content of the seventh character string in the first exemplary embodiment of the present disclosure corresponds to the first heating amount in the present exemplary embodiment, and the contents of the third character string and the fifth character string or the contents of the ninth character string and the eleventh character string in the first exemplary embodiment of the present disclosure correspond to the first heating time in the present exemplary embodiment.

For example, in association table 1301, ID S0001 is assigned with a large-size rectangular shape with rounded corners as a shape of an object to be heated. Furthermore, as with label 1002 shown in FIG. 10A, a label shape that is an approximately square shape is registered, the label shape making characters “PACKED MEAL WITH CITRON FLAVOR FRIED CHICKEN” and heating information “500 W 2 MIN and 30 SEC, 1500 W 0 MIN and 45 SEC” identifiable. In this case, heating control information recognized by character information reading and analyzing unit 708 indicates “500 W 2 MIN and 30 SEC”, and heating control information registered in advance in information storage unit 205 indicates “500 W 150 SEC”.

FIG. 12A shows an example where food 1202 that is not subject to heating is put into heat-cooking device 1200 as described above. In this case, shape information of an image taken by imaging unit 1201 and heating control information indicating that heating control is not allowed are registered in information storage unit 205 with being associated with each other, which prevents the heating control from being erroneously performed.

Note that in the present exemplary embodiment, the example has been given where heat-cooking device 1200 is configured not to perform heating control in a case where predetermined shape information of food is recognized, but heat-cooking device 1200 may be configured not to perform heating control in a case where a predetermined label shape, character information of a food label attached to food, or barcode information is recognized.

Specifically, shape information of a label of food that is not subject to heating, character information, or barcode information is registered in information storage unit 205 with being associated with heating control information indicating that heating control is not performed. When food 1202 is put into heat-cooking device 1200 and is in a state where imaging unit 1201 can recognize food 1202, imaging unit 1201 takes an image of the interior of the chamber. Note that whether food 1202 is in the state where imaging unit 1201 can recognize food 1202 is determined by at least one of imaging unit 1201 and controller 203.

From the image taken by imaging unit 1201, label information reading and analyzing unit 707 detects and acquires shape information of a target food label. Furthermore, character information reading and analyzing unit 708 detects and acquires heating control character information or heating control barcode information. Controller 203 determines whether the shape of the food label, the heating control character information, or the heating control barcode information thus detected corresponds to information stored in information storage unit 205. In a case where the shape of the food label, the heating control character information, or the heating control barcode information thus detected corresponds to information registered (stored) in information storage unit 205, controller 203 acquires heating control information associated with the shape information from information storage unit 205. Then, even in a case where the user presses the heating start button, controller 203 controls heater 201 to prevent heater 201 from performing heating based on the heating control information associated with the shape information in information storage unit 205.

Note that examples of a label of food that is not subject to heating include a food label on which a mark unique to a store different from a store where heat-cooking device 100 is installed is printed. Furthermore, examples of character information that is not subject to heating include characters printed in a font different from a predetermined font. Furthermore, examples of barcode information that is not subject to heating include barcode information registered in a store different from a store where heat-cooking device 1200 is installed.

In heat-cooking device 1200 of the present exemplary embodiment, at least one of shape information of food, label shape information of a food label attached to the food, character information printed on the food label, and barcode information printed on the food label is read. Heat-cooking device 1200 of the present exemplary embodiment is configured such that, in a case where heating control information associated with the information thus read corresponds to heating control information indicating heating is not allowed, heating control is not performed. Such a configuration prevents food that is not suitable to be heated in heat-cooking device 1200 from being accidentally cooked.

### Fourth Exemplary Embodiment

In a fourth exemplary embodiment of the present disclosure, a description will be given of an example where heat-cooking device 1400 serves as heat-cooking system 1000 that is connected to a network.

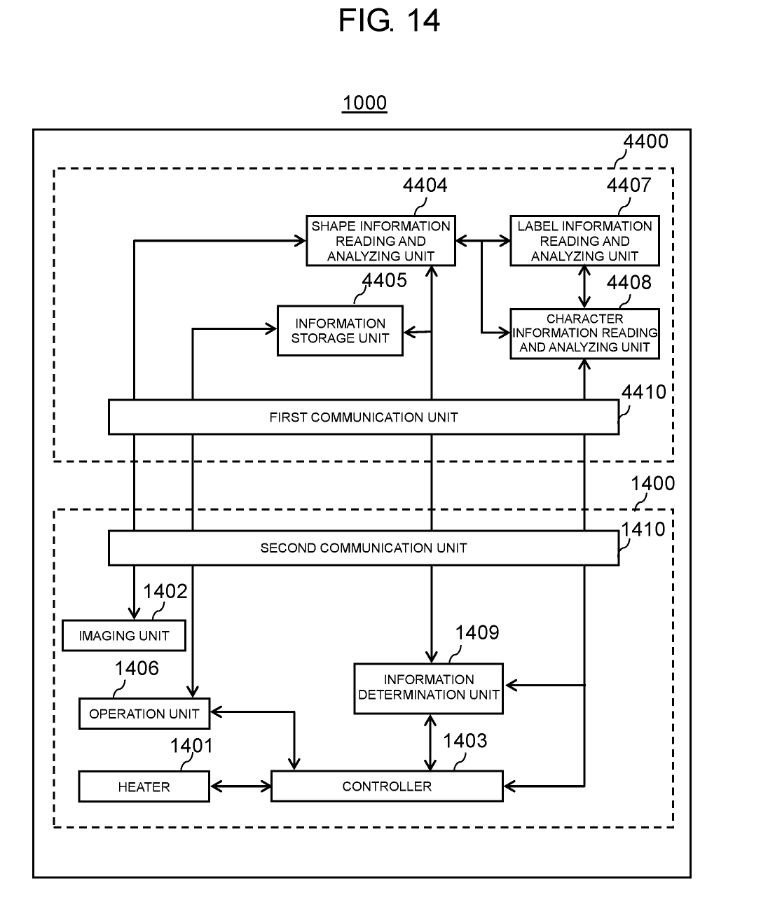

FIG. 14 is a block diagram showing a functional configuration of the heat-cooking system according to the fourth exemplary embodiment of the present disclosure.

As shown in FIG. 14, heat-cooking system 1000 of the fourth exemplary embodiment of the present disclosure includes heat-cooking device 1400 and external apparatus 4400. External apparatus 4400 is configured with, for example, a server or a portable terminal.

Heat-cooking device 1400 and external apparatus 4400 are interconnected over a network such as the Internet to be capable of communicating with each other.

Note that external apparatus 4400 may be configured to connect to not only heat-cooking device 1400 but also another heat-cooking device having a configuration and a function identical to the configuration and the function of heat-cooking device 1400.

A physical configuration of heat-cooking device 1400 is identical to the physical configuration of the heat-cooking device 100 of the first exemplary embodiment of the present disclosure; thus, the detailed description of the physical configuration will not be given herein.

A description will be given below of a functional configuration of heat-cooking device 1400.

Heat-cooking device 1400 includes, as shown in FIG. 14, heater 1401, imaging unit 1402, controller 1403, operation unit 1406, information determination unit (shape determination unit) 1409, and communication unit (first communication unit) 1410. Heater 1401, imaging unit 1402, and operation unit 1406 are respectively identical in terms of configuration and function to heater 201, imaging unit 202, and operation unit 206 of heat-cooking device 100 of the first exemplary embodiment of the present disclosure. Note that heat-cooking device 1400 may include a heating information display unit having a configuration and a function identical to the configuration and the function of heating information display unit 102 of heat-cooking device 100 of the first exemplary embodiment of the present disclosure.

Furthermore, information determination unit (shape determination unit) 1409 has a configuration and a function identical to the configuration and the function of information determination unit (shape determination unit) 709 of heat-cooking device 200 of the second exemplary embodiment of the present disclosure except that information determination unit 1409 has a function of sending heating control information to controller 1403.

External apparatus 4400 includes shape information reading and analyzing unit 4404, information storage unit 4405, label information reading and analyzing unit 4407, character information reading and analyzing unit 4408, communication unit (a second communication unit) 4410. Note that label information reading and analyzing unit 4407 and character information reading and analyzing unit 4408 each may be configured to serve as a component or a function of shape information reading and analyzing unit 4404.

Shape information reading and analyzing unit 4404 has a function identical to the function of shape information reading and analyzing unit 204 of heat-cooking device 100 of the first exemplary embodiment of the present disclosure. Information storage unit 4405 is located in external apparatus 4400 configured with a server or the like. Information storage unit 4405 stores shape information analyzed by shape information reading and analyzing unit 4404, heating control information based on which controller 1403 performs heating control, and the like. Information storage unit 4405 stores the shape information and the heating control information with the shape information and the heating control information associated with each other.

Heat-cooking device 1400 and external apparatus 4400 are interconnected over a network via communication unit 1410 and communication unit 4410 to be capable of communicating with each other. Specifically, communication unit 4410 of external apparatus 4400 transmits information such as heating control information stored in information storage unit 4405 to communication unit 1410 of heat-cooking device 1400. Furthermore, communication unit 4410 receives, from heat-cooking device 1400 via communication unit 1410, information such as image information of an object to be heated taken by imaging unit 1402 and heating control information set through operation unit 1406.

Communication unit 1410 of heat-cooking device 1400 transmits, to external apparatus 4400 via communication unit 4410, information such as image information of an object to be heated taken by imaging unit 1402 and heating control information set through operation unit 1406. Furthermore, communication unit 1410 receives, from external apparatus 4400 via communication unit 4410, information such as heating control information stored in information storage unit 4405.

In a case where external apparatus 4400 is configured with a portable terminal, the portable terminal may include a display unit that displays information such as image information of an object to be heated taken by imaging unit 1402 and heating control information stored in information storage unit 4405.

Controller 1403 controls heat-cooking device 1400 based on information such as heating control information received by communication unit 1410 and stored in information storage unit 4405.

Such a configuration causes processing such as image recognition processing and storage of analysis data to be performed in external apparatus 4400, which simplifies the configuration of heat-cooking device 1400 and facilitates processing such as an update on and a modification to a program for executing image recognition processing and the like. Furthermore, even when a data amount of information stored in large-capacity information storage unit 4405 becomes large, this configuration allows a data capacity of external apparatus 4400 to be easily increased, which allows large volume of information to be stored compared to the configuration where the information storage unit is located in heat-cooking device 1400.

Moreover, in a case a different heat-cooking device having a configuration and a function identical to the configuration and the function of heat-cooking device 1400 is connected to external apparatus 4400, information such as heating control information acquired by the different heat-cooking device is stored in information storage unit 4405 and is transmitted to communication unit 1410 of heat-cooking device 1400 via communication unit 4410 of external apparatus 4400. This configuration also allows controller 1403 to control heat-cooking device 1400 based on information such as heating control information received by communication unit 1410, stored in information storage unit 4405, and acquired from the different heat-cooking device.

As described below, a partially modified exemplary embodiment based on each of the above-described first to fourth exemplary embodiments of the present disclosure still lies within the scope of the present disclosure. Furthermore, modifications of the present disclosure to be described below are applied not only to each of the exemplary embodiments, and combinations of the modifications of the present disclosure and combinations of one or a plurality of the modifications of the present disclosure and any one of the first exemplary embodiment to the fourth exemplary embodiment of the present disclosure also lie within the scope of the present disclosure.

### (Modifications)

Heat-cooking device 100, 200, 1200 of the present disclosure may serve as a heat-cooking system that is capable of connecting to a network and in which heat-cooking device 100, 200, 1200 is controlled by a portable terminal or a server over the network. Such a heat-cooking system may be configured to cause processing such as image recognition processing to be performed in an external apparatus such as a portable terminal or a server.

Furthermore, the heat-cooking system and heat-cooking system 1000 of the fourth exemplary embodiment of the present disclosure may be configured to cause a display unit of a portable terminal connected to a network to display an image of an interior of heat-cooking device 100, 200, 1200, 14000.

Furthermore, heat-cooking device 100, 200, 1200, 1400 of the present disclosure may serve as not only a commercial-use apparatus used at, for example, a convenience store or a packed meal seller but also a home-use apparatus.

Furthermore, heat-cooking device 100, 200, 1200, 1400 of the present disclosure may be configured to cause the heating information display unit of heat-cooking device 100, 200, 1200, 1400 to display an image of an interior of the heating chamber taken by the imaging unit.

Furthermore, heat-cooking device 100, 200, 1200, 1400 of the present disclosure may be configured to cause the heating information display unit of heat-cooking device 100, 200, 1200, 1400 to display a character, a barcode, a shape of food, or a food label recognized by heat-cooking device 100, 200, 1200 or external apparatus 4400.

Furthermore, in a case where heat-cooking device 100, 200, 1200 of the present disclosure serves as the heat-cooking system connected to a network, heat-cooking device 100, 200, 1200 may be configured to cause a display unit of a portable terminal connected to a network to display a character, a shape, or the like recognized by the portable terminal or a server.

Furthermore, in the first to third exemplary embodiments of the present disclosure, the examples have been given where heat-cooking device 100, 200, 1200 includes, the heater, the imaging unit, the controller, the shape information reading and analyzing unit, the information storage unit, the operation unit, the label information reading and analyzing unit, and the character information reading and analyzing unit. However, the present disclosure is not limited to such a configuration, and heat-cooking device 100, 200, 1200 of the present disclosure may be configured such that a plurality of blocks (functions) including the heater and the like are configured with a single semiconductor element (for example, a microprocessor). This configuration not only allows a single controller to perform various processing but also allows for a decrease in the number of semiconductor elements with which a circuit board is populated, which in turn reduces a size of the circuit board.

Furthermore, heat-cooking device 100, 200, 1200, 1400 of the present disclosure may be configured such that not all but some of the blocks are configured with a single semiconductor element.

Note that in the present disclosure, heating control information (the first heating control information) set by a user corresponds to heating control information set by the user through the operation unit based on a heating time and the like read by the user from a label attached to an object to be heated. In contrast, heating control information (the second heating control information) associated with shape information of an object to be heated corresponds to heating control information such as heating information registered in the information storage unit with being associated with, for example, a shape of the object to be heated read by the shape information reading and analyzing unit. Therefore, the former heating control information and the latter heating control information may contain the same contents or may contain different contents.

Furthermore, in the present disclosure, heating control information for heating an object to be heated may correspond to heating control information set by a user or may correspond to heating control information associated with shape information of the object to be heated.

### INDUSTRIAL APPLICABILITY

As described above, the present disclosure provides a heat-cooking device, a heat-cooking device control method, and a heat-cooking system that causes heating control to be performed based on, for example, heating control information registered in advance with being associated with shape information of an object to be heated and the like read by the camera or the like, eliminates the need of a bothersome input task, and allows a user to easily cook food. Accordingly, the present disclosure is widely applicable to heat-cooking devices such as a microwave oven.

### REFERENCE MARKS IN THE DRAWINGS

100, 200, 1200, 1400: heat-cooking device
101: door panel
102: heating information display unit
103: selector
104: heat-cooking chamber (heating chamber)
105: lighting unit
106: camera
107, 1202: food (object to be heated)
201, 701, 1401: heater
202, 702, 1201, 1402: imaging unit
203, 703, 1403: controller
204, 704, 4404: shape information reading and analyzing unit
205, 705, 4405: information storage unit
206, 706, 1406: operation unit
707, 4407: label information reading and analyzing unit
708, 1408: character information reading and analyzing unit
709, 1409: information determination unit (shape determination unit)
301, 302, 303, 401: food (object to be heated)
301a, 302a, 303a, 401a: shape
402, 1002, 1006, 1009: label
403: heating control character target section
404: barcode target section
1000: heat-cooking system
1005: side surface
1410: communication unit (first communication unit)
4400: external apparatus
4410: communication unit (second communication unit)

1. A heat-cooking device comprising:
a heating chamber;
a heater configured to heat an object to be heated in the heating chamber;
an imaging unit configured to take an image of an interior of the heating chamber;
a controller configured to control heating generated by the heater;
a shape information reading and analyzing unit configured to read shape information of the object to be heated from the image taken by the imaging unit; and
an information storage unit where heating control information associated with the shape information of the object to be heated is registered,
wherein
in a case where the shape information read by the shape information reading and analyzing unit has been registered in the information storage unit,
the controller performs heating control based on the heating control information associated with the shape information registered in the information storage unit.

2. The heat-cooking device according to claim 1, wherein in a case where the shape information read by the shape information reading and analyzing unit has not been registered in the information storage unit, at least one of a shape of a label attached to the object to be heated and a character printed on the label is read as information from the image taken by the imaging unit, and the controller performs heating control based on at least one of the information of the shape of the label read and the information of the character which has been read.

3. The heat-cooking device according to claim 1, wherein
in a case where the shape information read by the shape information reading and analyzing unit has not been registered in the information storage unit,
the controller registers heating control information for heating the object to be heated in the information storage unit with the heating control information being associated with the shape information read by the shape information reading and analyzing unit.

4. The heat-cooking device according to claim 1, further comprising an operation unit through which heating control information set by a user is input,
wherein
in a case where the shape information read by the shape information reading and analyzing unit has not been registered in the information storage unit,
the controller registers the heating control information set through the operation unit in the information storage unit with the heating control information being associated with the shape information read by the shape information reading and analyzing unit.

5. The heat-cooking device according to claim 1, further comprising:
a label information reading and analyzing unit configured to read a shape of a label attached to the object to be heated; and
a character information reading and analyzing unit configured to read a character printed on the label,
wherein
the controller performs heating control based on the heating control information registered in the information storage unit, the heating control information being associated with at least one of the shape information of the object to be heated read by the shape information reading and analyzing unit, the shape information of the label attached to the object to be heated read by the label information reading and analyzing unit, and the character information printed on the label read by the character information reading and analyzing unit.

6. The heat-cooking device according to claim 1, further comprising a shape determination unit configured to determine whether the shape information read by the shape information reading and analyzing unit corresponds to the shape information registered in the information storage unit,
wherein
in a case where a score value resulting from converting the shape information read by the shape information reading and analyzing unit into a numerical form lies within a predetermined score value range, the predetermined score value range including a score value resulting from converting the shape information registered in the information storage unit into a numerical form,
the shape determination unit determines that the shape information of the object to be heated read by the shape information reading and analyzing unit corresponds to the shape information registered in the information storage unit, and
in a case where the score value resulting from converting the shape information read by the shape information reading and analyzing unit into a numerical form lies outside the predetermined score value range, the predetermined score value range including the score value resulting from converting the shape information registered in the information storage unit into a numerical form,
the shape determination unit determines that the shape information of the object to be heated read by the shape information reading and analyzing unit corresponds to shape information not registered in the information storage unit.

7. The heat-cooking device according to claim 1, wherein
in a case where the heating control information associated with the shape information read by the shape information reading and analyzing unit, registered in the information storage unit, and acquired by the controller corresponds to information indicating that heating is not allowed,
the controller performs heating control so as for the heating generated by the heater not to be performed.

8. The heat-cooking device according to claim 1, wherein
in a case where the heating control information associated with the shape information read by the shape information reading and analyzing unit, registered in the information storage unit, and acquired by the controller corresponds to information indicating that heating is not allowed,
the controller notifies the user that heating is not allowed by indication or voice.

9. A heat-cooking system comprising:
a heat-cooking device and an external apparatus, wherein
the heat-cooking device including;
a heating chamber,
a heater configured to heat an object to be heated in the heating chamber,
an imaging unit configured to take an image of an interior of the heating chamber,
a controller configured to control the heater for heating, and
a first communication unit configured to receive information transmitted from the external apparatus to the controller; and
the external apparatus including;
a shape information reading and analyzing unit configured to read shape information of the object to be heated from the image taken by the imaging unit,
an information storage unit where heating control information associated with the shape information of the object to be heated is registered, and
a second communication unit configured to transmit the heating control information registered in the information storage unit to the first communication unit,
wherein
the heat-cooking device and the external apparatus are interconnected over a network via the first communication unit and the second communication unit to be capable of communicating with each other, and
in a case where the controller determines that the shape information read by the shape information reading and analyzing unit and transmitted from the second communication unit to the controller via the first communication unit has been registered in the information storage unit,
the controller performs heating control based on the heating control information which has been associated with the shape information read by the shape information reading and analyzing unit and has been registered in the information storage unit.

10. The heat-cooking system according to claim 9, wherein in a case where the controller determines that the shape information read by the shape information reading and analyzing unit has not been registered in the information storage unit,
at least one of a shape of a label attached to the object to be heated and a character printed on the label is read as information from the image taken by the imaging unit, and the controller performs heating control in accordance with heating control information based on at least one of the shape of the label and the character read as the information.

11. The heat-cooking system according to claim 9, wherein
in a case where the controller determines that the shape information read by the shape information reading and analyzing unit has not been registered in the information storage unit,
the controller registers heating control information for heating the object to be heated in the information storage unit with the heating control information being associated with the shape information read by the shape information reading and analyzing unit.

12. The heat-cooking system according to claim 9, wherein
the heat-cooking device further includes;
a label information reading and analyzing unit configured to read a shape of a label attached to the object to be heated, and
a character information reading and analyzing unit configured to read a character printed on the label, and
the controller performs heating control based on the heating control information registered in the information storage unit, the heating control information being associated with at least one of the shape information of the object to be heated read by the shape information reading and analyzing unit, the shape information of the label attached to the object to be heated read by the label information reading and analyzing unit, and the character information printed on the label read by the character information reading and analyzing unit.

13. A heat-cooking device control method applied to a heat-cooking device, the heat-cooking device including;
a heating chamber,
a heater configured to heat an object to be heated in the heating chamber,
an imaging unit configured to take an image of an interior of the heating chamber,
a controller configured to control the heater for heating,
an operation unit through which heating control information set by a user is input,
a shape information reading and analyzing unit configured to read shape information of the object to be heated from the image taken by the imaging unit, and
an information storage unit where heating control information
associated with the shape information of the object to be heated is registered, the heat-cooking device control method comprising:
performing heating control based on the heating control information registered in the information storage unit, the heating control information being associated with the shape information read by the shape information reading and analyzing unit, in a case where the shape information read by the shape information reading and analyzing unit has been registered in the information storage unit.

14. The heat-cooking device control method according to claim 13, comprising reading as information at least one of a shape of a label attached to the object to be heated and a character printed on the label from the image taken by the imaging unit and performing heating control based on at least one of the shape of the label and the character which has been read as the information, in a case where the shape information read by the shape information reading and analyzing unit has not been registered in the information storage unit.

15. The heat-cooking device control method according to claim 13, comprising registering the heating control information set through the operation unit in the information storage unit with the heating control information being associated with the shape information read by the shape information reading and analyzing unit.
